(19) United States
(12) Patent Application Publication
(10) Pub. No.: US 2024/0211518 A1
(43) Pub. Date: Jun. 27, 2024

(54) AUTOMATED DOCUMENT INTAKE SYSTEM

(71) Applicant: Legal Facts, LLC, San Clemente, CA (US)

(72) Inventors: Andrew Christian Puzder, Mesa, AZ (US); Melinda Sylstra, Capistrano Beach, CA (US); Jeremy Isermann, Corona, CA (US); Diane Duncklee, Vero Beach, FL (US); Arsalan Ahmed, Panama City (PA); Yohendry Hurtado, Panama City (PA); Javier Troya, Panama City (PA); Roberto Duran, Bogotá (CO); Luis Viera, Panama City (PA)

(21) Appl. No.: 18/468,539

(22) Filed: Sep. 15, 2023

Related U.S. Application Data
(63) Continuation of application No. 17/519,441, filed on Nov. 4, 2021, now abandoned.
(60) Provisional application No. 63/110,189, filed on Nov. 5, 2020.

(51) Int. Cl. G06F 16/906; G06F 16/93; G06F 40/10; G06F 40/114; G06F 40/279; G06V 30/416

(52) U.S. Cl. CPC G06F 16/906; G06F 16/93; G06F 40/10; G06F 40/114; G06F 40/279; G06V 30/416

(57) ABSTRACT

Systems, methods, and articles for performing document intake, such as intake of legal documents. The systems disclosed herein receive pages of documents, automatically group the pages to identify documents in a legal matter, and automatically update a status of the legal matter based on the identified documents. This is achieved by one or more of receiving a file which contains one or more pages, grouping the pages, determining a document type for each group, obtaining a plurality of phases for a legal matter, assigning a phase to each group, and organizing the groups based on the assigned phase for each group.

### TECHNICAL FIELD

The present disclosure is related generally to performing document intake, and particularly to performing bulk grouping and classification of pages of documents to associate documents with a legal matter or task.

### BACKGROUND

### Description of the Related Art

Legal proceedings can be very complex with many different parts involving many different parties. These parties not only include the legal parties to the legal proceeding, such as a lawsuit, but also their attorneys, experts, support staff, and other interested persons. Each of these parties may have different tasks to perform or to monitor at different times throughout the legal proceeding. Keeping track of which documents correspond to each of the tasks, as well as which documents are related to the legal proceeding, is a difficult and complex process. Furthermore, documents may not be received in a particular order, may be improperly combined, such as if they originated in paper form, may be received in bulk, etc. Each of these scenarios makes the task of keeping track of each of the documents and their corresponding tasks complex. It is with respect to these and other considerations that the embodiments described herein have been made.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

FIG. 1 is a context diagram of an environment for providing an automated document intake system to users in accordance with embodiments described herein.

FIG. 2 is a process to obtain a file and identify documents within the file, according to some embodiments of the automated document intake system.

FIG. 3 is a process to group pages obtained by the automated document intake system based on their content, according to some embodiments of the automated document intake system.

FIG. 4 depicts a sample page and an array generated by using OCR on the sample page.

FIG. 5 is a flow diagram depicting a process to classify groups of pages, according to some embodiments of the automated document intake system.

FIG. 6 illustrates a use case example screenshot of a graphical user interface in accordance with embodiments described herein.

FIG. 7 depicts a system diagram that describes one implementation of computing systems for implementing embodiments described herein.

### DETAILED DESCRIPTION

Classifying a large number of documents, even with the help of computing systems, is time-consuming, and requires human intervention to accurately and reliably identify documents. Additionally, in some situations, such as in the legal context, documents, once classified, can be organized in a manner that indicates their importance. In order to overcome the drawbacks of document classification systems, an automated document intake system is described herein. The automated document intake system is configured to receive a large file containing any number of documents and to identify the documents, and their type, within the file in an efficient manner. The automated document intake system is also able to organize the documents to indicate their relative importance. The documents may be located in a large file, e.g., a data blob or file containing one or more scanned documents, and may additionally contain corrupted files or documents, duplicates of certain documents, documents missing portions of their content, etc. Additionally, the automated document intake system is able to eliminate the need for page separators for document digitization and document classification.

In some embodiments, the automated document intake system may receive one or more documents combined in a single file. The automated document system identifies individual documents contained within a single file, and processes each document according to its type.

In some embodiments, the automated document intake system receives a file containing one or more documents. The automated document intake system performs optical character recognition (OCR) on the file to receive the text of the file. The automated document intake system classifies each page of the one or more documents in the file, such as determining the first page, cover page, title page, last page, etc., by using the text of the file retrieved from the OCR. The automated document intake system groups the pages together based on their classifications. The automated document intake system may create a new group of pages when a specific type of page, such as a first page, cover page, last page, etc., is encountered. The automated document intake system identifies the header and footer of each page and analyzes those portions of the pages to assist in the determination of what type of document the page belongs to. The automated document intake system may use the header and footer to identify different pages rather than page separators. In some embodiments, the automated document intake system may use page separators in conjunction with the header and footer to identify different pages.

The automated document intake system utilizes the document type of the page, the page grouping, or some combination thereof to determine whether the pages belong to the same document or different documents. The automated document intake system identifies the type of the document based on a score calculated from one or more attributes of the document, such as the content of the header, the content of the footer, the presence of certain words within the document, the attributes of certain words in the document, etc.

The automated document intake system may utilize artificial intelligence and/or machine learning techniques to group the pages together into separate documents. The automated document intake system may utilize artificial intelligence and/or machine learning techniques to identify the document type of each of the separate documents.

Additionally, in some embodiments, the automated document intake system may utilize the document's type, the document's content, or other information relating to the document, or some combination thereof, to determine the purpose of each document in the file. The automated document intake system may use that information to further organize the documents to indicate additional information to a user of the automated document intake system. For example, in the legal context, the purpose or type of the document may be used to determine at what point in a legal matter the document was used, and the document can be placed in a “timeline” representing major events of the matter. Continuing this example, in the case of a patent application, the automated document intake system can determine at what point in the patent prosecution process a document belongs, e.g. whether it is the first, second, third, final, etc. office action; whether it is the initial application; whether it is a notice of allowance; etc.

The following is an example embodiment of the Automated Document Intake System in the context of a legal documents relating to ongoing litigation. This embodiment is meant only to provide an example of how an Automated Document Intake System may be implemented, and is not intended to encompass every implementation or embodiment of an Automated Document Intake System.

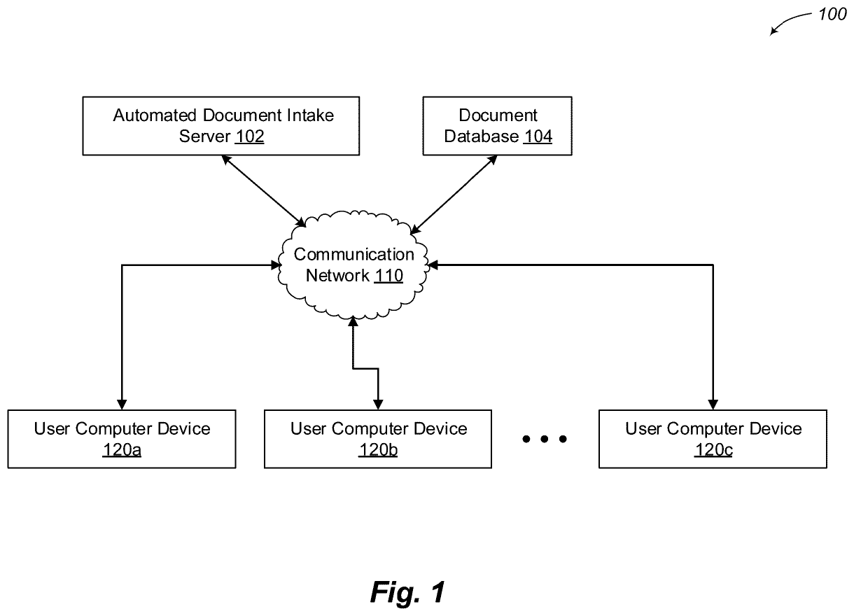

FIG. 1 is a context diagram of an environment 100 for providing an automated document intake system to users in accordance with embodiments described herein. Environment 100 includes an automated document intake server 102 in communication with a document database 104 and a plurality of user computer devices 120a-120c (collectively 120) via a communication network 110. Examples of the user computer devices 120a-120c include smart phones, tablet computers, laptop computers, desktop computers, or other computing devices.

The automated document intake server 102 is a computer device, such as a server computer or cloud-computing resources, that analyzes and identifies documents obtained from a user computer device 120. As described herein, documents pertain to legal documents in an ongoing litigation. In some embodiments, the documents may pertain to a case, arbitration proceeding, appeal process, patent drafting or prosecution process, contract negotiation, or other legal proceeding that has multiple phases. As described in more detail below, the automated document intake server 102 obtains a file containing multiple pages, groups the pages into groups based on their content, and classifies each group of pages as a document. The documents may then be organized based on the phase of the legal process, in one example the phase in litigation.

The automated document intake server 102 stores the documents in document database 104. In some embodiments, the document database 104 may be a standalone or separate computing device from the automated document intake server 102. In other embodiments, the document database 104 is stored in the memory of the automated document intake server 102.

The automated document intake server 102 receives documents from the user computer devices 120a-120c. In some embodiments, the user computer devices 120a-120c access a graphical user interface via an interactive website or web portal hosted or created by the automated document intake server 102. In other embodiments, the user computer devices 120a-120c may have stored thereon an application or program that renders a graphical user interface to the users of the user computer devices 120a-120c. In some embodiments, a user may upload one or more files containing multiple pages or documents to the automated document intake server 102 via a user computer device 120. In some embodiments, the automated document intake system is configured to retrieve, or receive, new files from the user computer device 120 as each file becomes available. In yet other embodiments, the functionality of the automated document intake server 102 is provided by the user computer devices 120 themselves, such as via an application or program installed on the user computer devices 120.

The user computer devices 120 may receive user input indicating one or more files, and may provide the indicated files to the automated document intake server 102 via communication network 110. The user input indicating one or more files may include, but is not limited to, individual documents, documents with pages that are out of order, documents with missing content, unrelated documents, unrelated pages, copies of pages, etc.

The communication network 110 may be configured to couple various computing devices to transmit content/data from one or more computing devices to one or more other computing devices. For example, communication network 110 may be the Internet, X.25 networks, or a series of smaller or private connected networks that carry the content and other data. Communication network 110 may include one or more wired or wireless networks.

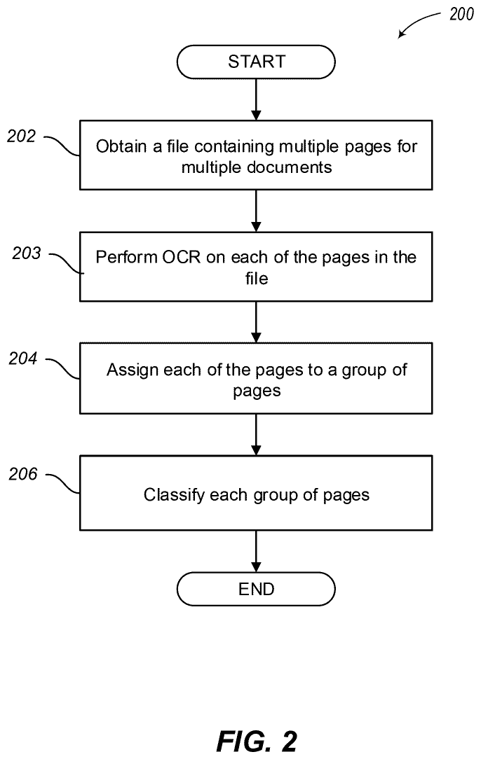

The operation of certain aspects will now be described with respect to FIGS. 2-5. In at least one of various embodiments, processes 200, 300, and 500 described in conjunction with FIGS. 2, 3, and 5 May be implemented by or executed via circuitry or on one or more computing devices, such as the automated document intake server in FIG. 1, a user computer device 120, etc.

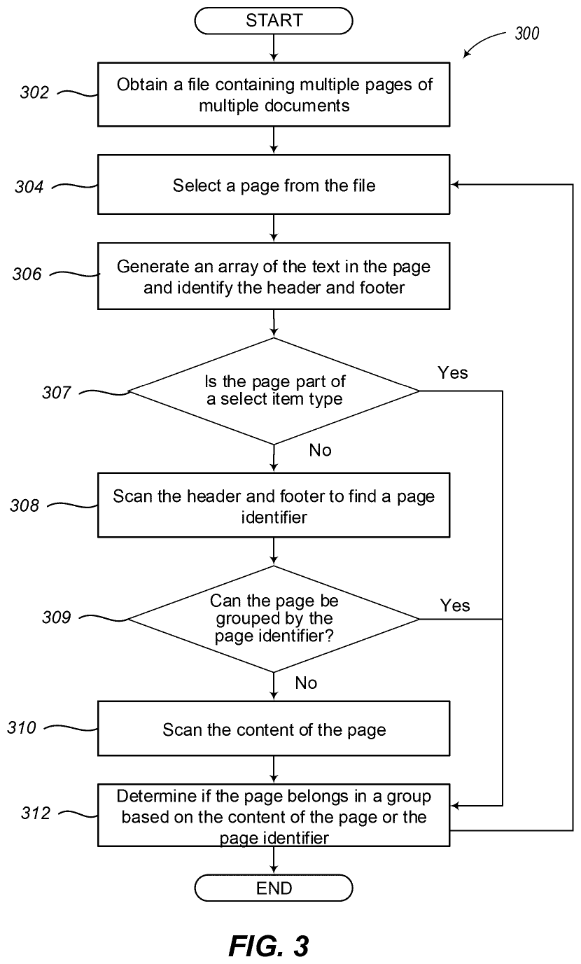

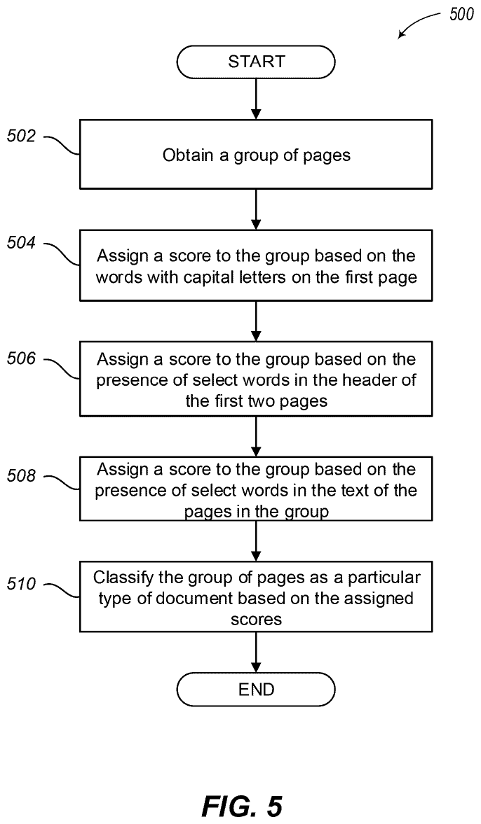

FIG. 2 is a process 200 to obtain a file and identify documents within the file, according to some embodiments of the automated document intake system. Process 200 begins, after a start block, at block 202, where the automated document intake system obtains a file containing multiple pages for multiple documents. Next, at block 203, the automated document intake system performs OCR on each page contained in the file. Next, at block 204, the automated document intake system assigns each of the pages to a group of pages, which is described in more detail below in conjunction with FIG. 3. Finally, at block 206, the automated document intake system classifies each group of pages, which is described in more detail below in conjunction with FIG. 5.

FIG. 3 is a process 300 to group pages obtained by the automated document intake system based on their content, according to some embodiments of the automated document intake system. The automated document intake system may use the automated document intake server 102 to perform the process described in FIG. 3. The automated document intake system may use the user computer device 120 may perform the process described in FIG. 3. Process 300 begins, after a start block, at block 302, where the automated document intake system obtains a file containing a plurality of pages belonging to a plurality of documents. Next, at block 304, the automated document intake system selects a page from the file.

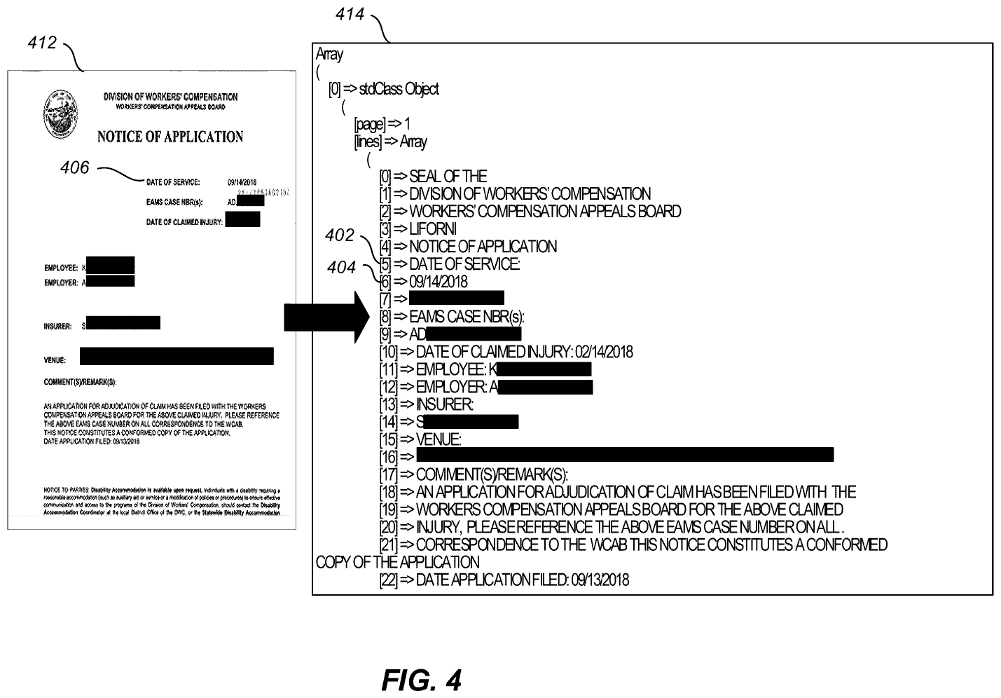

Next, at block 306, the automated document intake system creates an array representing the text of the selected page. One or more OCR techniques are performed on the selected page to extract the text from the selected page, where each element in the array contains text that was separated from other text in the selected page by white space that exceeds a predetermined amount of white space. In some embodiments, the array may include elements which contain text that was separated from other text by line breaks in the selected page. One example illustration of such an array is depicted in FIG. 4.

Briefly, FIG. 4 depicts a sample page 412 and an array 414 generated by using OCR on the sample page. In FIG. 4, each separate numbered line (e.g., [0] to [22]) is a separate element in the array 414. For example, array element 402 contains “DATE OF SERVICE:” and array element 404 contains “Sept. 12, 2018”. These elements are extracted from the sample page 412 as separate elements because the text in the sample page 412 is separated by white space exceeding a threshold amount—even though the text is on a same line in the sample page 412. For example, the original text 406 contains “DATE OF SERVICE:”, a white space (e.g., a tab), and “Sept. 12, 2018”. As shown in FIG. 4, the original text 406 was split into elements 402 and 404 where a large amount of white space was detected by the OCR.

In some embodiments, the automated document intake system identifies a header and footer in the array. The header and footer are defined by a select number of elements in the array, such as, for example, the first six elements of the array for the header and the last six elements of the array for the footer.

Next, at decision block 307, the automated document intake system determines whether the selected page is part of a select item type. In some embodiments, the automated document intake system determines whether the selected page is part of a select item type by identifying whether the document originally included line numbers along the side of the document, such as, for example, in a pleading, proof of service, patent application, etc. In some embodiments, the automated document intake system analyzes the numbers along the side of the document to determine if it is part of a select item type. For example, identifying whether the page is part of a pleading or proof of service includes determining how many lines are numbered, dividing that number by 28, and classifying that page as part of a pleading or proof of service if there are at least 14 numbered lines present, or 50% of the number of numbered lines in a pleading paper (e.g. 28 lines). In some embodiments, the automated document intake system may classify the selected page as part of a select item type based on a determination of whether select words appear on the selected page. For example, a selected page may be identified as a proof of service page if the words proof of service are found on the selected page. In some embodiments, the select item type is included in an existing group of pages based on its identification, e.g. a proof of service is included in the previous group of pages. If the automated document intake system determines that the page is part of a select item type, the process continues to block 312; otherwise, the process continues to block 308.

At block 308, the automated document intake system scans the header for a page identifier, such as, for example, text similar to “X of Y pages”, “page X of Y”, “page X”, etc., to determine how many pages belong in the group and where the page should be located in the group. The automated document intake system may then create a group based on the page identifier. In some embodiments, the automated document intake server performs the actions in block 308 for the header and the footer of the page separately.

Next, at decision block 309, the automated document intake system determines whether it can group the selected page by using the page identifiers. If the automated document intake system can group the selected page by using the page identifiers the process continues to block 312. If the automated document intake system cannot group the selected page by using the page identifiers, the process continues to block 310.

At block 310, the automated document intake system scans the content of the selected page, which may include the text, formatting, or any combination thereof in the body, header, and footer. In some embodiments, the automated document intake system scans the content of the selected page by iterating through the selected page's content. In some embodiments, the automated document intake system identifies numbers within the content of the selected page. In some embodiments, the automated document intake system identifies dates and/or times within the content of the selected page. In some embodiments, the automated document intake system identifies certain words or phrases, such as “pages attached”, within the content of the selected page.

After block 310, if, at decision block 307, the page is part of a select item type, or if, at decision block 309, the page can be grouped by page identifier, process 300 continues at block 312. At block 312, the automated document intake system determines the whether the selected page belongs in a group. The automated document intake system groups the selected page with a group of pages based on the content of the selected page, the presence of a page identifier within the selected page, or based on the determination that the page is part of a select item type. In some embodiments, the automated document intake system attaches the selected page to the previous group if it determines the page should belong to the group, for example a proof of service page may be added to the previous group if it determines that the proof of service page is one page away from the previous group. In some embodiments, when the next page is the first page of another group, the automated document intake system stops the current grouping. In some embodiments, the automated document intake system determines if a page is the first page in the group based on whether it finds text in the page numbering it as the first page, for example, “page 1”, “pg 1”, “1 of 7 ”, “-1-”, etc.

In some embodiments, when the automated document intake system groups pages based on a page identifier, such as “X of Y pages”, the automated document intake system will create a group of pages starting with page number X up until page number Y. In some embodiments, the automated document intake system predicts which page number should come next within the group based on page number X, for example if X is 2 the automated document intake system predicts the next page will be page 3. In some embodiments, after predicting which page number the next page should have, the automated document intake system searches for a page with that page number in the file, for example, the automated document intake system may search for “3 of 7”, “3 of *” (“*” being a wildcard character), etc. In some embodiments, if the next page is not found within the file, the automated document intake system joins the headers and footers for each page in the file and searches for the page identifier among the headers and footers of each page. In some embodiments, when a page is numbered “page 2”, “2 of Y”, etc., and the previous page does not include a page number, then the previous page may be inferred as being “page 1” in the group and the current page is added to the group of the previous page.

In some embodiments, when grouping pages by content, the automated document intake system groups pages based on the similarity of numbers identified within each page. In some embodiments, the automated document intake system groups pages based on the similarity of numbers present in the header or footer if the numbers have at least a predetermined number of digits. The similarity of the numbers present in the header or footer may be determined by having a threshold number of digits or characters which are similar up to a threshold value or percentage. For example, if two pages have numbers in the header or footer which are at least 8 digits long, and the numbers are 75% similar (i.e. at least 75% of the characters in each of the numbers are the same), then the system infers that the numbers are significant in identifying or labeling a document and the pages are included in the same group. Such numbers may include docket numbers, application numbers, case numbers, etc. In another example, if two pages have numbers outside of the header and footer which are 15 digits long and 75% similar the pages may be grouped together. In some embodiments, the automated document intake system uses a different predetermined number of digits for the content of the page outside the header and footer than the predetermined number for the content of the page inside the header and footer, for example requiring at least 15 digits for a number outside of the header and footer, and requiring 8 digits for a number inside the header and footer.

In some embodiments, when grouping pages by content, the automated document intake system groups pages based on whether the pages include similar dates and/or times. In some embodiments, the automated document intake system checks for a similar date after finding a date and time. In some embodiments, the automated document intake system checks the headers and footers for the similar dates and/or times.

In some embodiments, when grouping pages by content, when the automated document intake system identifies that the previous page and current page are both pleadings, the previous and current pages are grouped together.

In some embodiments, when grouping pages by content, the automated document intake system groups the pages based on the similarity of the headers or footers. In some embodiments, the similarity of pages is decided based on the presence of a page identifier, which can include text such as “pages attached”, “page X”, etc. In some embodiments, the automated document intake system groups the pages based on whether the header or footer are a predetermined percentage similar, e.g. 80% similar. In some embodiments, each line of the header and/or footer is matched to a corresponding line in the header or footer of the page being compared, and the pages are grouped if the lines are similar enough, for example, if the first header's first line is 80% similar to the second header's first line, the pages may be grouped together. In some embodiments, all of the lines in the headers or footers of each page being compared are compared to a corresponding line, and the percentage of lines that are similar determine whether the pages should be grouped together if the percentage of lines that are similar exceeds a predetermined threshold. In some embodiments, the threshold percentage of lines that are similar is lowered if “pages attached” or similar text is found in the header or footer.

As part of block 312, the automated document intake system may add a page to a group as soon as it determines the page may belong to the group. In some embodiments, the automated document intake system may use several methods to determine whether the page belongs to a group, then add the page to a group based on the grouping determined by the methods. After block 312, if the automated document intake system detects that there are ungrouped pages in the file, the process loops back to block 304. If the automated document intake system does not detect ungrouped pages in the file the process ends after block 312.

In some embodiments, once the pages are grouped together, the automated document intake system identifies each group of pages as a document such as in the process described in FIG. 5.

FIG. 5 is a flow diagram depicting a process 500 to classify groups of pages, according to some embodiments of the automated document intake system. In some embodiments, the groups are classified by using a score based on attributes that corresponds to a master document list. In some embodiments, if consecutive groups are classified as the same document, the groups are combined to create one document. In some embodiments, if groups are classified as the same document but separated by a group that could not be classified, the classified and unclassified groups are combined to create one document. In some embodiments, the automated document intake system assigns a score to the group based on the content of a subset of pages of the group, for example, the first two pages.

In some embodiments, the automated document intake system includes a list of document names used to classify the groups, such as “pleading”, “proof of service”, “motion in limine”, “wage statement”, “deposition”, etc. In some embodiments, the automated document intake system includes a list of terms, which correspond to each document name. For example, a wage statement document would correspond to terms such as “wage statement”, “Walk Through Appearance Sheet”, “wage calculator”, “payroll register report”, “earning record”, “pay statement”, “confidential wage”, etc. In some embodiments, the automated document intake system searches the document for the longest search term first, before moving on to the next longest, etc. until a search term is found.

FIG. 5 begins, after a start block, at block 502 where the automated document intake system obtains a group of pages to classify into a document. Next, at block 504, the document intake system assigns a score to the group of pages based on the number of words with capital letters that match a search term on each page. In some embodiments, if the search term containing a capital letter is found on the first page, the added score is increased. For example, if a search term is found, the automated document intake system may add 2 points to the page's score, but if the search term is on the first page, the 2 points may be multiplied by 4, and the score is increased by 8 points instead of 2. In some embodiments, the words with capital letters must have at least a minimum number of letters, e.g. at least two letters. In some embodiments, the words with capital letters are compared to search terms that have more than a minimum number of letters, e.g. at least five letters. In some embodiments, the automated document intake system compares words with capital letters to search-terms with a symbol, such as a hyphen, percent sign, dollar sign, ampersand, etc., even if the search-term has less than the minimum number of letters. In some embodiments, words with capital letters are compared to search terms regardless of the length of the word with capital letters if the word contains a symbol, such as a hyphen, percent sign, dollar sign, etc.

Next, at block 506, the automated document intake system assigns a score to the group based on the presence of select words that appear in the header of each page. In some embodiments, the automated document intake system assigns a higher score if there are exact matches to the select words. In some embodiments, the automated document intake system multiplies the assigned score by a predetermined amount if the match is found on the first page of the group. In some embodiments, if the match is not exact, but is similar up to a certain threshold (e.g. 90% similar) the automated document intake system adds a pre-defined or pre-selected amount to the score of the group. In some embodiments, the automated document intake system is able to recognize common typos, mistakes, etc., of the search terms, and may still add a pre-defined or pre-selected amount to the score if the search term is incorrectly spelled.

Next, at block 508, the automated document intake system assigns a score to the group based on the presence of select words within the full text of the page. In some embodiments, the score assigned in block 508 for matches to select words is less than the score assigned in block 506 for matches to select words. In some embodiments, the score is multiplied by a predetermined amount if the select word is found on the first page. In some embodiments, the terms are only compared to select words that have at least a minimum number of letters, unless the select word includes a symbol. For example, if the minimum number of letters is five, “lien” May not be compared to the terms in the page, but “PR-2” May be compared because it contains a symbol.

Next, at block 510, the group of pages is classified as a document based on the score that the group received in blocks 504-508. In some embodiments, as part of performing the actions in blocks 504-508, a score is assigned to individual pages in each group, and the score for each page is aggregated to determine a score for the group which is used to classify the group as a document. In some embodiments, the automated document intake system includes a list of scores corresponding to document types, and the group is assigned a document type by comparing its score to the list of scores. In some embodiments, if the group cannot be classified based on its score it will be classified as an “unnamed document”. In some embodiments, the group is saved in the document database along with its classification.

In some embodiments, after grouping and classifying the pages, the automated document intake system produces a summary of the analysis. The summary of the analysis may include information such as: the total number of pages, the time to upload the file, the time to generate images of the pages, the time to perform OCR on the pages, the time to group and classify the pages, the total time spent processing the pages, the total number of groups, the total number of classified groups, the methods used to classify the pages, etc.

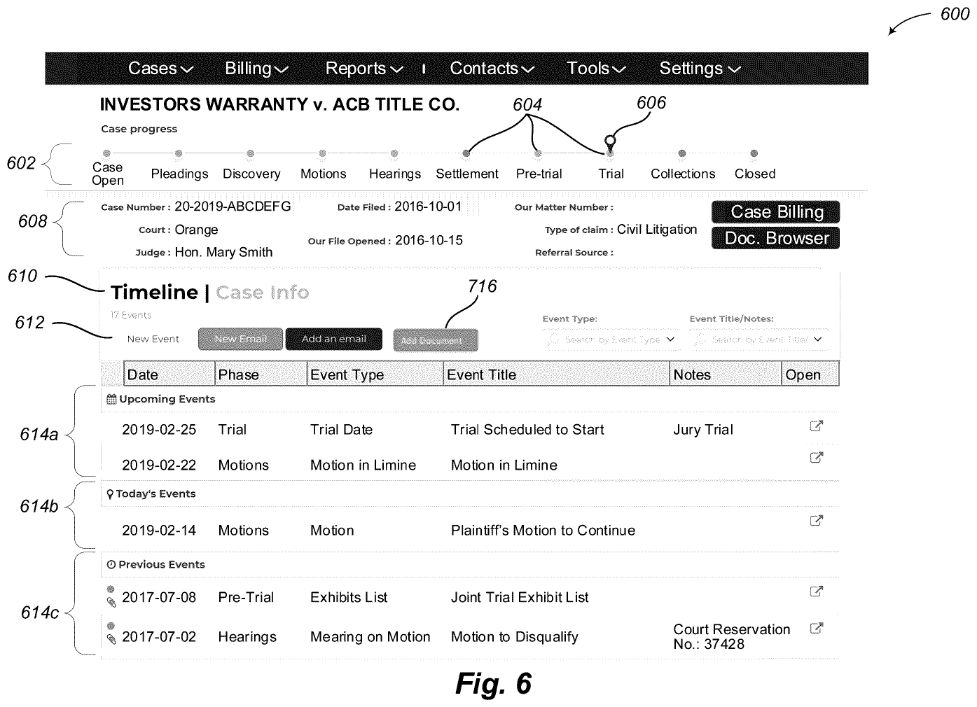

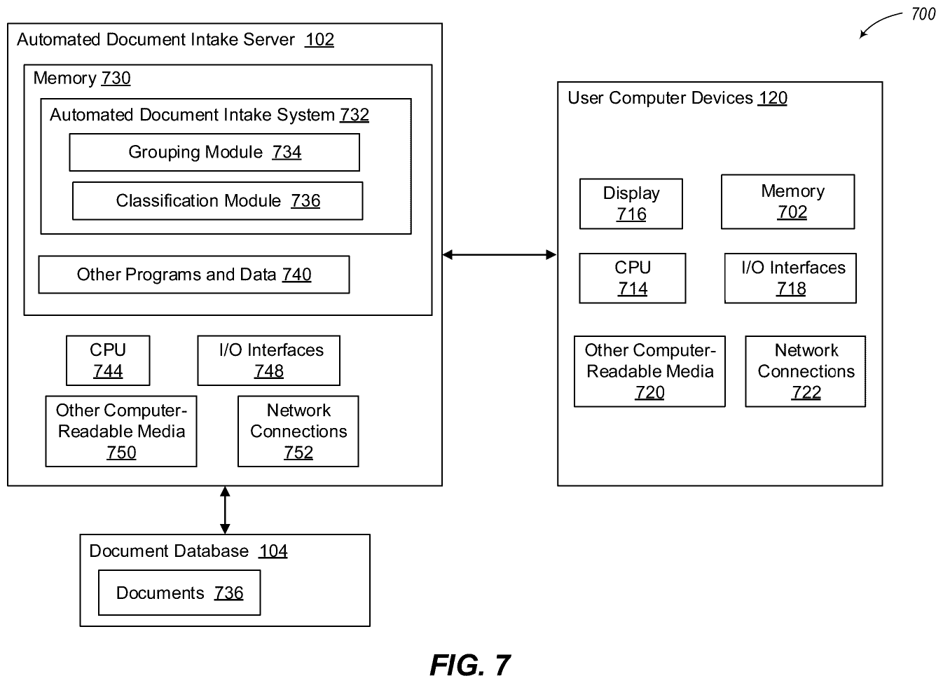

A use case example of the automated document intake server will now be described with respect to FIGS. 6 and 7. In at least one of various embodiments, interface 600 and system 700 described in conjunction with FIGS. 6 and 7 May be used to implement an automated document intake system.

FIG. 6 illustrates a use case example screenshot of a graphical user interface in accordance with embodiments described herein. Interface 600 in FIG. 6 may be one of a collection of graphical user interfaces that are generated and presented to a user, and may be collectively referred to as a graphical user interface.

Interface 600 in FIG. 6 is a graphic user interface of a legal matter status bar 602 with which the user can interact. The status bar 602 includes a plurality of phase representations 604. Each phase representation 604 is associated with a phase of the legal matter. In this illustrated example, the phases include: matter open, pleadings, discovery, motions, hearings, settlement, pre-trial, trial, collections, and closed. Other numbers and types of phases may also be employed. In various embodiments, the phases represented on the status bar 602 are set by a developer or administrator and cannot be changed by a user. In other embodiments, the user may define, or select from pre-defined phases, the phases are to be represented on the status bar 602. In yet other embodiments, the user may be enabled to split a pre-defined phase into multiple representations or combine multiple representations into a single representation. For example, the user may combine a pre-trial phase representation with a trial phase representation.

A marker 606 is included in the status bar 602 and is associated with a current phase of the phase representations 604. In various embodiments, the current phase may be the phase with a most recently added document. The marker 606 moves from one phase representation 604 to another as the legal matter progresses based on the addition of various documents.

The interface 600 also includes matter information 608. The matter information 608 may include, but is not limited to: matter number, date filed or started, client or attorney matter number, court or jurisdiction for the matter, judge or reviewer or overseer, type of matter, etc.

The interface 600 may also display a timeline 610. The timeline 610 lists a plurality of events 614a-614c (collectively 614) already entered by the user. In some embodiments, the automated document intake system automatically generates events based on documents identified by the automated document intake system. The events 614 may be listed in chronological order. In some embodiments, the events 614 may be grouped into upcoming events 614a, today's events 614b, and previous events 614c, as illustrated. Each event 614 includes a due date, phase, event type, and event title. The events 614 may also include milestones, notes, attachments, or other information.

A user can create a new event 614 by clicking on the new event button 612, which may navigate to another screen or open another window configured to allow the user to create a new event. In other embodiments, the user can create a new event 614 by clicking on a particular phase representation 604. By clicking on a particular phase representation 604, the system may navigate to another screen configured to allow the user to create a new event where at least some of the information is pre-selected based on the particular phase representation 604. For example, if the user clicks on the phase representation 604 for “Hearings” then “Hearings” may be preselected, preassigned, or prepopulated as the phase name or phase category for the new event.

A user can add a document, or multiple documents, by clicking on the add document button 616, which may navigate to another screen or open another window configured to allow the user to add a new document. In some embodiments, the automated document intake system creates one or more events based on the one or more added documents added by the user.

When a user adds a document, or group of documents, such as by clicking the add document button 616, the user may upload the document to the automated document intake system. The automated document intake system then processes the document to identify the contents of each page of the document, such as in the process described in FIG. 2. In some embodiments, the automated document intake system then performs OCR on each page of the document to extract the characters in each page. In some embodiments, the OCR may be configured to output an array, list, etc., of strings representing characters separated by white space with each element of the array containing a portion of the text of the page, as shown in FIG. 4. The automated document intake system may classify a predetermined number of elements in the list to represent the page header and page footer. For example, the first six elements of the list and the last six elements of the list may represent the header and footer of the page respectively.

In some embodiments, after the automated document intake system has obtained the text of each page, such as by using OCR techniques, the automated document intake system groups the pages into groups, such as in the process described in FIG. 3. In some embodiments, before performing the process described in FIG. 3, the automated document intake system compares the text of each page to identify duplicate pages. In some embodiments, before performing the process described in FIG. 3, the automated document intake system removes the duplicate pages from the list of pages, and the process described in FIG. 3 is not performed on the duplicate pages. In some embodiments, before performing the process described in FIG. 3, the automated document intake system identifies each blank page. In some embodiments, before performing the process described in FIG. 3, the automated document intake system removes the blank pages from the list of pages, and the process described in FIG. 3 is not performed on the blank pages.

FIG. 7 depicts a system diagram that describes one implementation of computing systems for implementing embodiments described herein. System 700 includes automated document intake server 102, document database 104, and user computer devices 120.

One or more special-purpose computing systems may be used to implement automated document intake server 102 to receive multiples pages, group the pages, and classify each of the groups as a type of document, as described herein. Accordingly, various embodiments described herein may be implemented in software, hardware, firmware, or in some combination thereof.

The automated document intake server 102 includes memory 730, one or more central processing units (CPUs) 744, I/O interfaces 748, other computer-readable media 750, and network connections 752. The automated document intake server 102 may include other computing components that are not shown for ease of illustration.

Memory 730 may include one or more various types of non-volatile and/or volatile storage technologies. Examples of memory 730 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 730 is utilized to store information, including computer-readable instructions that are utilized by CPU 744 to perform actions and embodiments described herein.

For example, memory 730 may have stored thereon automated document intake system 732. Automated document intake system 732 includes grouping module 734 and classification module 736 to employ embodiments described herein. For example, the grouping module 734 groups individual pages together. The group is then used to represent a document. The classification module 736 classifies the groups as certain documents based on the content of the pages in the group, and the content of pages in other groups. The grouping module 734, the classification module 736, or both, may interact with other computing devices, such as document database 104 to store and retrieve documents or groups of pages or a user computer device 120 to receive pages or documents from a user. Although illustrated separately, the functionality of the grouping module 734 and the classification module 736 may be performed by a single module. Memory 730 may also store other programs and data 740 to perform other actions associated with the operation of automated document intake server 102.

Network connections 752 are configured to communicate with other computing devices, such as user computer devices 120 or other devices not illustrated in this figure. In various embodiments, the network connections 752 include transmitters and receivers (not illustrated) to send and receive data as described herein. I/O interfaces 748 may include a keyboard, audio interfaces, video interfaces, or the like. Other computer-readable media 750 may include other types of stationary or removable computer-readable media, such as removable flash drives, external hard drives, or the like.

User computer devices 120 receive information from the automated document intake server 102 to present to a user the grouped pages and classified documents. Users can additionally use the user computer devices 120 to provide information to the automated document intake server 102 regarding the grouped pages and documents. One or more special-purpose computing systems may be used to implement each user computer device 120. Accordingly, various embodiments described herein may be implemented in software, hardware, firmware, or in some combination thereof.

User computer devices 120 may include memory 702, one or more central processing units (CPUs) 714, display 716, I/O interfaces 718, other computer-readable media 720, and network connections 722. Memory 702 may include one or more various types of non-volatile and/or volatile storage technologies, similar to what is described above for memory 730.

Memory 702 is utilized to store information, including computer readable instructions that are utilized by CPU 714 to perform actions. In some embodiments, memory 702 may have stored thereon a user interface configured to allow the user to transmit documents to an automated document intake server 102, and/or configured to display classified groups of pages and documents received from the automated document intake server 102. Memory 702 may also store other programs and data 710 to perform other actions associated with the operation of user computer device 120.

Display 716 is configured to provide content to a display device for presentation of the documents, groups of documents, statistics related to classifying and grouping the documents, etc. In some embodiments, display 716 includes the display device, such as a television, monitor, projector, or other display device. In other embodiments, display 716 is an interface that communicates with a display device.

I/O interfaces 718 may include a keyboard, audio interfaces, video interfaces, or the like, which may be configured to enable a user to interact with the user computer device 120. Network connections 722 are configured to communicate with other computing devices, such as automated document intake server 102 or other computing devices not illustrated in this figure. In various embodiments, the network connections 722 include transmitters and receivers (not illustrated) to send and receive data as described herein. Other computer-readable media 720 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for performing document intake, the method comprising:
receiving a file that includes one or more pages, each of the one or more pages containing corresponding content;
grouping the one or more pages into one or more groups based on the corresponding content in each of the one or more pages;
determining a document type for each corresponding group of the one or more groups based on the corresponding content of corresponding pages in the corresponding group;
obtaining a plurality of phases of a legal matter, the plurality of phases representing a chronological order of events throughout the legal matter;
assigning a phase, of each of the plurality of phases, for each of corresponding group of the one or more groups based at least on the corresponding content of corresponding pages in the corresponding group and the document type for the corresponding group; and
organizing each corresponding group of the one or more groups in a list based on the determined phase of the corresponding group.

2. The method of claim 1, wherein grouping the one or more pages comprises:
performing optical character recognition (OCR) on each page of the one or more pages to identify one or more characters on the page; and
determining whether a respective page of the one or more pages belongs in a respective group of the one or more groups based on the recognized characters.

3. The method of claim 2, wherein determining whether a respective page of the one or more pages belongs in a respective group of the one or more groups further comprises:
identifying a page identifier for each page of the one or more pages based on the recognized characters; and
determining whether the respective page of the one or more pages belongs in the respective group of the one or more groups based on the identified page identifier.

4. The method of claim 3, wherein determining whether a respective page of the one or more pages belongs in a respective group of the one or more groups based on the identified page identifier further comprises:
identifying a header and a footer for the respective page;
determining whether the page identifier is included in the header or the footer for the respective page; and
determining whether the respective page belongs in the respective group based on the determination of whether the page identifier is included in the header or the footer for the respective page.

5. The method of claim 1, wherein determining a document type for each corresponding group further comprises:
determining a score for the corresponding group;
receiving data indicating one or more score ranges for one or more document types; and
determining the document type for each corresponding group based on the determined score and the data indicating one or more score ranges.

6. The method of claim 5, wherein determining a score for the corresponding group further comprises:
identifying one or more attributes of one or more groups of one or more characters in at least one page included in the corresponding group; and
determining the score for the corresponding group based on the identified attributes.

7. The method of claim 6, wherein the one or more attributes in the at least one page include one or more of: one or more capital letters in a pre-determined word on the at least one page, one or more pre-determined words on the at least one page, one or more pre-determined phrases on the at least one page, one or more symbols on the at least one page, one or more locations of a word on the at least one page, one or more locations of one or more symbols on the at least one page, or one or more measures of a similarity between one or more words identified on the at least one page and one or more pre-determined words.

8. A system for performing document intake, the system comprising:
at least one nontransitory processor-readable storage medium that stores at least one of instructions or data; and
at least one processor communicatively coupled to the at least one nontransitory processor-readable storage medium, in operation, the at least one processor:
receives a file that includes one or more pages, each of the one or more pages containing corresponding content;
groups the one or more pages into one or more groups based on the corresponding content in each of the one or more pages;
determines a document type for each corresponding group of the one or more groups based on the corresponding content of corresponding pages in the corresponding group;
obtains a plurality of phases of a legal matter, the plurality of phases representing a chronological order of events throughout the legal matter;
assigns a phase, of each of the plurality of phases, for each of corresponding group of the one or more groups based at least on the corresponding content of corresponding pages in the corresponding group and the document type for the corresponding group; and
organizes each corresponding group of the one or more groups in a list based on the determined phase of the corresponding group.

9. The system of claim 8, wherein to group the one or more pages the at least one processor:
performs optical character recognition (OCR) on each page of the one or more pages to identify one or more characters on the page; and
determines whether a respective page of the one or more pages belongs in a respective group of the one or more groups based on the recognized characters.

10. The system of claim 9, wherein to determine whether a respective page of the one or more pages belongs in a respective group of the one or more groups the at least one processor:
identifies a page identifier for each page of the one or more pages based on the recognized characters; and
determines whether the respective page of the one or more pages belongs in the respective group of the one or more groups based on the identified page identifier.

11. The system of claim 10, wherein to determine whether a respective page of the one or more pages belongs in a respective group of the one or more groups based on the identified page identifier the at least one processor:
identifies a header and a footer for the respective page;
determines whether the page identifier is included in the header or the footer for the respective page; and
determines whether the respective page belongs in the respective group based on the determination of whether the page identifier is included in the header or the footer for the respective page.

12. The system of claim 8, wherein to determine a document type for each corresponding group the at least one processor:
determines a score for the corresponding group;
receives data indicating one or more score ranges for one or more document types; and
determines the document type for each corresponding group based on the determined score and the data indicating one or more score ranges.

13. The system of claim 12, wherein to determine a score for the corresponding group the at least one processor:
identifies one or more attributes one or more groups of one or more characters in at least one page included in the corresponding group; and
determines the score for the corresponding group based on the identified attributes.

14. The system of claim 13, wherein the one or more attributes in the at least one page include one or more of: one or more capital letters in a pre-determined word on the at least one page, one or more pre-determined words on the at least one page, one or more pre-determined phrases on the at least one page, one or more symbols on the at least one page, one or more locations of a word on the at least one page, one or more locations of one or more symbols on the at least one page, or one or more measures of a similarity between one or more words identified on the at least one page and one or more pre-determined words.

15. A nontransitory processor-readable storage medium that stores at least one of instructions or data, the instructions or data, when executed by at least one processor, cause the at least one processor to:
receive a file that includes one or more pages, each of the one or more pages containing corresponding content;
group the one or more pages into one or more groups based on the corresponding content in each of the one or more pages;
determine a document type for each corresponding group of the one or more groups based on the corresponding content of corresponding pages in the corresponding group;
obtain a plurality of phases of a legal matter, the plurality of phases representing a chronological order of events throughout the legal matter;
assign a phase, of each of the plurality of phases, for each of corresponding group of the one or more groups based at least on the corresponding content of corresponding pages in the corresponding group and the document type for the corresponding group; and
organize each corresponding group of the one or more groups in a list based on the determined phase of the corresponding group.

16. The nontransitory processor-readable storage medium of claim 15, wherein the at least one processor is further caused to:
perform optical character recognition (OCR) on each page of the one or more pages to identify one or more characters on the page; and
determine whether a respective page of the one or more pages belongs in a respective group of the one or more groups based on the recognized characters.

17. The nontransitory processor-readable storage medium of claim 16, wherein the at least one processor is further caused to:
identify a page identifier for each page of the one or more pages based on the recognized characters; and
determine whether the respective page of the one or more pages belongs in the respective group of the one or more groups based on the identified page identifier.

18. The nontransitory processor-readable storage medium of claim 15, wherein the at least one processor is further caused to:
determine a score for the corresponding group;
receive data indicating one or more score ranges for one or more document types; and
determine the document type for each corresponding group based on the determined score and the data indicating one or more score ranges.

19. The nontransitory processor-readable storage medium of claim 18, wherein the at least one processor is further caused to:
identify one or more attributes of one or more groups of one or more characters in at least one page included in the corresponding group; and
determine the score for the corresponding group based on the identified attributes.

20. The nontransitory processor-readable storage medium of claim 19, wherein the one or more attributes in the at least one page include one or more of: one or more capital letters in a pre-determined word on the at least one page, one or more pre-determined words on the at least one page, one or more pre-determined phrases on the at least one page, one or more symbols on the at least one page, one or more locations of a word on the at least one page, one or more locations of one or more symbols on the at least one page, or one or more measures of a similarity between one or more words identified on the at least one page and one or more pre-determined words.
